(19) United States
(12) Patent Application Publication
(10) Pub. No.: US 2011/0097056 A1
(43) Pub. Date: Apr. 28, 2011

(54) SYSTEM AND METHOD FOR RESOLUTION OF CLOSED CAPTIONING AND SUBTITLE CONFLICT

(75) Inventor: Mark Gilmore Mears, Zionsville, IN (US)

(73) Assignee: SHENZHEN TCL NEW TECHNOLOGY LTD., Shekou, Shenzhen, Guangdong (CN)

(21) Appl. No.: 12/997,730

(22) PCT Filed: Oct. 27, 2008
(86) PCT No.: PCT/US2008/081359

§ 371 Date: Dec. 13, 2010

(30) Foreign Application Priority Data
Jun. 24, 2008 (CN) 20081006011.8

(51) Int. Cl. H04N 5/92

(52) U.S. Cl. 386/244; 386/E05.001

(57) ABSTRACT

There is provided a system and method for resolution of conflicts between closed captioning and subtitle settings on a media device. More specifically, in one embodiment, there is provided n electronic media device, comprising a processor, and a memory, wherein the processor and memory are configured to cooperate to present a preferred one of closed captions or subtitles of a media program for display and configured to prevent presentation of the other for display based on a preference setting when closed captioning and subtitle settings are both enabled.

### FIELD OF THE INVENTION

The present invention relates generally to video devices. In particular, an embodiment of the present invention relates to a system and method for resolving conflicts between presenting closed captioning and subtitles on a video device.

### BACKGROUND OF THE INVENTION

This section is intended to introduce the reader to various aspects of art, which may be related to various aspects of embodiments of the present invention that are described and/or claimed below. This discussion is believed to be helpful in providing the reader with background information to facilitate a better understanding of the various aspects of embodiments of the present invention. Accordingly, it should be understood that these statements are to be read in this light, and not as admissions of prior art.

Many existing media devices, such as televisions, are equipped with textual language features that facilitate comprehensible viewing access for a wide variety of people. For example, many media devices support multiple language features that facilitate presentation of subtitles in a selected language. Specifically, a television may enable a user to select a language in which to present subtitles for dialogue and/or onscreen text of a program, such as a movie or television show. In a specific example, a user may select French as the language for subtitles, and, as a result, a program including dialogue and/or onscreen text in English may be presented with textual subtitles in French corresponding to the English dialogue and/or on-screen text. Also, many media devices support closed captioning for hearing impaired viewers. Closed captioning provides an onscreen textual version of the audio for a program. For example, a textual version of dialogue and sound effects for a program may be presented on a television screen when a closed captioning option is active on the television.

Many systems provide both closed captioning and subtitle features. However, closed captioning data is often handled separately from subtitle data in existing media devices. For example, with regard to a digital video disk (DVD), closed captioning data is often distributed via line 21 of a vertical blanking interval (VBI), while subtitle data is often distributed as a bitmap overlay, which can be turned on and off via a DVD player. Further, closed captioning data and subtitle data may each require different types of decoding. Accordingly, a media device may include two or more separate decoding features to facilitate presentation of both closed captioning and subtitles.

It is now recognized that there are issues associated with provision of both subtitles and closed captioning. For example, a viewer may become frustrated with a television program because both closed captioning and subtitles are being presented at the same time. Indeed, the text from closed captioning may overlap the text for subtitles, thus, making the textual version of the dialogue for the program difficult to read. Also, the text from the closed captioning and the subtitles may combine to take up a large part of the television's display, thus degrading the visual content of the programming.

### BRIEF DESCRIPTION OF THE DRAWINGS

Advantages of the invention may become apparent upon reading the following detailed description and upon reference to the drawings in which:

FIG. 1 is a block diagram of an electronic device in accordance with present embodiments;

FIG. 2 is a block diagram representing a method in accordance with present embodiments; and

FIG. 3 is a block diagram representing software modules stored on a computer-readable medium in accordance with present embodiments.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

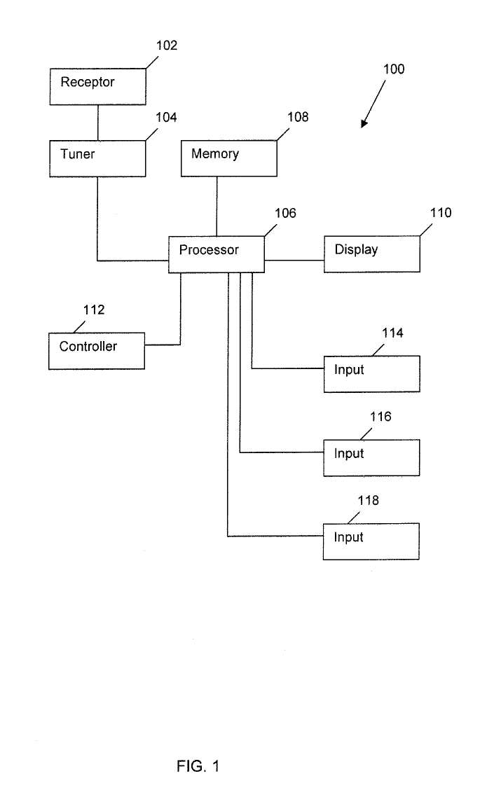

FIG. 1 is a block diagram of an electronic device in accordance with an exemplary embodiment of the present invention. The electronic device (e.g., a television, set top box, or computer system) is generally indicated by the reference number 100. The electronic device 100 comprises various subsystems represented as functional blocks in FIG. 1. Those of ordinary skill in the art will appreciate that the various functional blocks shown in FIG. 1 may comprise hardware elements (including circuitry), software elements (including computer code stored on a machine-readable medium or computer-readable medium) or a combination of both hardware and software elements.

The electronic device 100 comprises at least one receptor 102, a tuner 104, a processor 106, a memory 108, a display 110, a controller 112 (e.g., a remote control), and various peripheral inputs 114, 116, and 118 (e.g., a DVD player). The memory 108 may comprise a tangible machine-readable medium adapted to hold machine-readable computer code that causes the processor 106 to perform an exemplary method in accordance with present embodiments. For example, the memory 108 and the processor 106 may cooperate to resolve conflicts between closed captioning and subtitle features of the electronic device 100.

Embodiments of the present invention are directed to a system and method for resolving conflicts between closed captioning and subtitle features of a media device. Specifically, in a device (e.g., a television and DVD player combination) that allows decoding of closed captions and subtitles from a media source (e.g., DVD or broadcast), the device is configured to display either closed captions or subtitles, not both. Indeed, even when both closed captions and subtitles are enabled, present embodiments may display only one. For example, although the receptor 102 may receive code relating to both closed captioning and subtitles, and the device 100 may be configured to interpret both types of associated code, present embodiments may select only one of the two types for display based on a preference.

The determination of whether to display closed captions or subtitles may be made based on a user-specified preference. For example, a menu setting available via present embodiments may allow a user to select between options of “Always show closed captions” or “Always show subtitles” when both are enabled. This menu setting may default from the manufacturer to either setting. However, it may be desirable to default to the display of subtitles because they are often more aesthetically pleasing. In some embodiments, the determination of whether to display closed captions or subtitles may be made based on a factory-set preference. It should be noted that if neither closed captions nor subtitles are enabled, neither will be displayed.

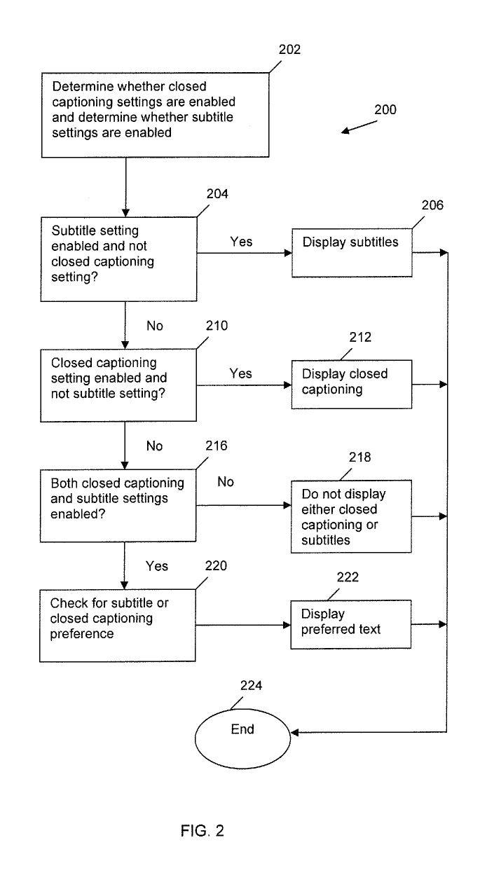

FIG. 2 is a block diagram representing a method in accordance with present embodiments. The method is generally indicated by reference numeral 200. While the method 200 includes specific steps, it should be noted that it is merely representative of particular embodiments. In some embodiments, certain steps may be added and others may not be included.

The method 200 begins with a determination of whether closed captioning settings are enabled and a determination of whether subtitle settings are enabled, as represented by block 202. These determinations may be utilized throughout the method 200 to guide process actions, as will be discussed in detail below. It should be noted that the determinations of block 202 may be performed during an initial turn-on process of a media device (e.g., television), each time new media is selected for display, upon user activation, and so forth. For example, block 202 may be performed when a channel is changed or a DVD is initially accessed.

Once determinations of whether closed captioning and/or subtitle settings are enabled, the process continues to a set of queries and actions. For example, in the illustrated embodiment, as represented by block 204, a first query determines whether the subtitle setting is enabled in conjunction with the closed captioning setting being disabled. If the subtitle is setting is enabled and the closed captioning setting is disabled, the method 200 proceeds to facilitate display of the subtitles, as represented by block 206. Otherwise, the method 200 proceeds to block 210.

Block 210 represents a second query, wherein a determination is made as to whether the closed captioning setting is enabled in conjunction with the subtitle setting being disabled. If the closed captioning setting is enabled and the subtitle setting is disabled, the method 200 facilitates display of the closed captioning, as represented by block 212. Otherwise, the method 200 proceeds to block 216.

Block 216 represents a third query, wherein a determination is made as to whether both closed captioning and subtitle settings are enabled. If the closed captioning setting and the subtitle settings are not both enabled, they are both disabled. Accordingly, the method proceeds to block 218, which represents not displaying either closed captioning or subtitles. However, if both closed captioning and subtitle settings are enabled, the method proceeds to block 220.

Block 220 represents determining a preference for either closed captioning or subtitles. For example, block 220 may represent querying a user regarding the user's preference. In another example, block 220 may represent accessing a predefined preference setting. Once the preference is determined in block 220, the method proceeds to block 222 and displays either subtitles or closed captions based on the determined preference. This may be achieved by blocking interpretation of the code associated with subtitles or closed captioning, whichever was not preferred. For example, if a user or factory setting indicates that subtitles are preferred, subtitles and not closed captions may be presented for display because only code associated with subtitles is actually interpreted.

Block 224 represents the end of the method 200. After each of the actions represented by blocks 206, 212, 218, and 222, the method 200 proceeds to the end at block 224. It should be noted that the method 200 may be reinitiated when a different media source is accessed or when the media device performing the method 200 is reset.

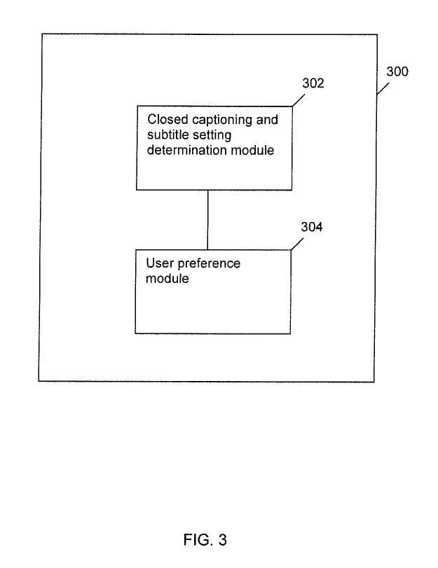

FIG. 3 is a block diagram representing software modules stored on a computer-readable medium 300 (e.g., hard disk, floppy disk, or CD) in accordance with present embodiments. The modules include a closed captioning and subtitle setting determination (CCSSD) module 302 and a user preference module 304. The CCSSD module 302 may include programming or code configured to determine whether or not both closed captioning and subtitle settings are enabled. If a determination is made by the CCSSD module 302 that both closed captioning and subtitle settings are available and enabled, the user preference module 304 may be employed to determine which is preferred. The user preference module 304 may represent a user defined or factory defined preference. In one embodiment, the user preference module 304 may include programming or code configured to provide a selection menu for a user to designate a preference. Once the preference is determined, the CCSSD module 302 may be configured to present only the preference for display. For example, if a user designated closed captioning as preferred in the user preference module, the CCSSD module 302 may display closed captioning and prevent display of subtitles.

It should be noted that while FIG. 3 is described as representing software modules, as would be understood by one of ordinary skill in the art, the modules may also be representative of hardware in some embodiments. Further, it should be noted that embodiments of the present invention may include a computer or other electronic device capable of reading the software modules or including corresponding hardware modules.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. An electronic media device, comprising:
a processor; and
a memory, wherein the processor and memory are configured to cooperate to present a preferred one of closed captions or subtitles of a media program for display and configured to prevent presentation of the other for display based on a preference setting, when closed captioning and subtitle settings are both enabled.

2. The electronic media device of claim 1, wherein the electronic media device comprises a television.

3. The electronic media device of claim 1, wherein the electronic media device comprise a DVD player.

4. The electronic media device of claim 1, wherein the electronic media device comprises a computer.

5. The electronic media device of claim 1, wherein the electronic media device comprises a combination DVD player and television.

6. The electronic media device of claim 1, wherein the processor and memory are configured to determine whether the closed captioning setting is enabled.

7. The electronic media device of claim 1, wherein the processor and memory are configured to determine whether the subtitle setting is enabled.

8. The electronic media device of claim 1, wherein the processor and memory are configured to provide a menu prompting a user to select the preference setting.

9. The electronic media device of claim 1, wherein the memory stores a user preference module configured to determine the preference setting.

10. The electronic media device of claim 1, comprising a receptor configured to receive code relating to subtitles.

11. The electronic media device of claim 1, comprising a receptor configured to receive code relating to closed captions.

12. A method, comprising:
determining that a media device has closed captioning and subtitle settings enabled simultaneously;
determining a preference between closed captioning and subtitles; and
presenting a preferred one of closed captions or subtitles for display based on the preference without presenting the other.

13. The method of claim 12, comprising displaying the preferred one of closed captions or subtitles on a display screen.

14. The method of claim 12, wherein determining the preference comprises prompting a user to input the preference.

15. The method of claim 12, wherein determining the preference comprises reading a preference setting stored in a memory.

16. The method of claim 12, comprising storing a default value in a memory as the preference.

17. The method of claim 12, comprising prompting a user to select a language for subtitles or closed captions.

18. The method of claim 12, comprising interpreting code associated with the preferred one of closed captions or subtitles and blocking code associated with the other.

19. An electronic device, comprising:
means for determining that a media device has closed captioning and subtitle settings enabled simultaneously;
means for determining a preference between closed captioning and subtitles; and
means presenting a preferred one of closed captions or subtitles for display based on the preference without presenting the other.
